(19) United States
(12) Patent Application Publication
(10) Pub. No.: US 2017/0372298 A1
(43) Pub. Date: Dec. 28, 2017

(54) METHOD AND APPARATUS FOR ACTIVATING VIRTUAL CARD

(71) Applicant: Beijing Xiaomi Mobile Software Co., Ltd., Beijing (CN)

(72) Inventors: Yifan ZHU, Beijing (CN); Yang CHEN, Beijing (CN); Wankun YANG, Beijing (CN)

(73) Assignee: Beijing Xiaomi Mobile Software Co., Ltd., Beijing (CN)

(21) Appl. No.: 15/628,377

(22) Filed: Jun. 20, 2017

Related U.S. Application Data
(63) Continuation of application No. PCT/CN2016/086690, filed on Jun. 22, 2016.

(51) Int. Cl. G06Q 20/34; G06Q 20/32; G06F 21/32

(52) U.S. Cl. CPC G06Q 20/351; G06Q 20/354; G06F 21/32; G06Q 20/3227

(57) ABSTRACT

The present disclosure relates to a method, an apparatus and a non-transitory computer-readable storage medium for activating a virtual card. The method includes: displaying an interface for selecting a virtual card to be activated upon receiving an instruction, where the interface for selecting the virtual card to be activated is configured to display at least two types of virtual cards in one or more pre-determined formats; determining a target virtual card where the target virtual card is the virtual card selected in the interface for selecting the virtual card to be activated; acquiring information to be authenticated when the target virtual card requires authentication, and activating the target virtual card when the authentication is passed; and directly activating the target virtual card when the target virtual card does not require the authentication.

### CROSS-REFERENCE TO RELATED APPLICATIONS

The present application is based upon and claims priority to PCT international Application PCT/CN2016/086690 filed Jun. 22, 2016, the entire contents of which are incorporated herein by reference.

### TECHNICAL FIELD

The present disclosure generally relates to the field of terminal technology, and more particularly, relates to a method, an apparatus and a non-transitory computer-readable storage medium for activating a virtual card.

### BACKGROUND

With the development of the terminal technology, a mobile terminal such as a mobile phone may have payment function by simulating a bank card or a transportation card such as a bus card. Such simulation may be referred to as mobile payment. In general, the bus card requires convenience, while the bank card requires convenience and safety. Therefore, there is a need for activating a virtual card which can meet the requirements for both virtual cards to achieve both convenience and safety.

### SUMMARY

The present disclosure provides a method, an apparatus and a non-transitory computer-readable storage medium for activating a virtual card. In a first aspect, a method for activating a virtual card is provided. The method may include displaying an interface for selecting a virtual card to be activated upon receiving an instruction, where the interface for selecting the virtual card to be activated may be configured to display at least two types of virtual cards in one or more pre-determined formats; determining a target virtual card where the target virtual card is the virtual card selected in the interface for selecting the virtual card to be activated; acquiring information to be authenticated when the target virtual card requires authentication, and activating the target virtual card when the authentication is passed; and directly activating the target virtual card when the target virtual card does not require the authentication.

In a second aspect, an apparatus for activating a virtual card is provided. The apparatus may include: a processor; and a memory for storing instructions executable by the processor; where the processor may be configured to: display an interface for selecting a virtual card to be activated upon receiving an instruction for displaying the interface, where the interface for selecting the virtual card to be activated is configured to display at least two types of virtual cards in one or more pre-determined formats; determine a target virtual card where the target virtual card is the virtual card selected in the interface for selecting the virtual card to be activated; acquire information to be authenticated when the target virtual card requires authentication, and activate the target virtual card when the authentication is passed; and directly activate the target virtual card when the target virtual card does not require the authentication.

In a third aspect, a non-transitory computer-readable storage medium is provided that stores instructions, executable by a processor in an apparatus for activating a virtual card in a terminal, may cause the processor to perform displaying an interface for selecting a virtual card to be activated upon receiving an instruction for displaying the interface, where the interface for selecting the virtual card to be activated may be configured to display at least two types of virtual cards; determining a target virtual card where the target virtual card is the virtual card selected in the interface for selecting the virtual card to be activated; acquiring information to be authenticated when the target virtual card requires authentication, and activating the target virtual card when the authentication is passed; and directly activating the target virtual card when the target virtual card does not require the authentication.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for activating a virtual card according to an exemplary embodiment;

FIG. 2 is a flow chart illustrating a method for activating a virtual card according to an exemplary embodiment;

FIG. 3 is a schematic diagram illustrating a display interface of a virtual card according to an exemplary embodiment;

FIG. 4 is a block diagram illustrating an apparatus for activating a virtual card according to an exemplary embodiment; and

FIG. 5 is a block diagram illustrating an apparatus 500 for activating a virtual card according to an exemplary embodiment.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

In order to make the objects, the technical solutions and advantages more clear, the present disclosure will be described in further detail with reference to the embodiments and the accompanying drawings. Here, the illustrative embodiments of the present disclosure and the description thereof are not intended to limit the present disclosure, but to explain the present disclosure.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an example is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

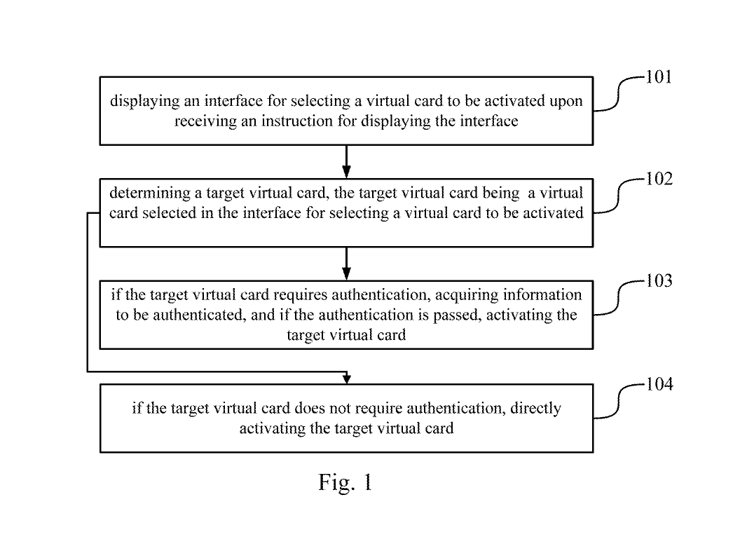

FIG. 1 is a flow chart illustrating a method for activating a virtual card according to an exemplary embodiment. As shown in FIG. 1, the method for activating a virtual card may be applied in a terminal, and may include the following steps.

At step 101, an interface for selecting a virtual card to be activated is displayed upon receiving an instruction for displaying the interface. The interface for selecting a virtual card to be activated may be configured to display at least two types of virtual cards.

At step 102, a target virtual card is determined. The target virtual card may be a virtual card selected in the interface for selecting a virtual card to be activated.

At step 103, if the target virtual card requires authentication, information to be authenticated is acquired. If the authentication is passed, the target virtual card is activated.

At step 104, if the target virtual card does not require authentication, the target virtual card is directly activated.

In the embodiment of the present disclosure, when the terminal stores more than one type of virtual cards, a selection interface may be developed and provided for the user to select a virtual card, and the specific payment manner may be determined accordingly. Therefore, the operation can be simplified.

In one possible implementation, the method further may include: upon detecting a designated device within a preset distance to the terminal, triggering the instruction for displaying the interface; or upon detecting a designated action with respect to the terminal, triggering the instruction for displaying the interface.

In one possible implementation, after the step of determining the target virtual card, the method further may include: determining whether the target virtual card requires authentication according to a card identification of the target virtual card; and determining the target virtual card requires authentication if the card identification of the target virtual card belongs to a first type of identifications; and determining the target virtual card does not require authentication if the card identification of the target virtual card belongs to a second type of identifications.

In one possible implementation, if the target virtual card requires authentication, the step of acquiring information to be authenticated may include: if the target virtual card requires authentication, acquiring fingerprint information of a user; and comparing the acquired fingerprint information with previously stored fingerprint information. If the acquired fingerprint information matches with the previously stored fingerprint information, the authentication is passed; and if the acquired fingerprint information does not match with the previously stored fingerprint information, the authentication is not passed.

In one possible implementation, if the authentication is passed, the step of activating the target virtual card may include: if the authentication is passed, acquiring corresponding data of the target virtual card from a security element (SE) module of the terminal, and sending the data to a designated device through a near field communication (NFC) module of the terminal.

In one possible implementation, the at least two types of virtual cards may include a virtual bank card and a virtual bus card.

All of the above alternative technical solutions may be combined to form other alternative embodiments of the present disclosure in any manner, and the description thereof is not elaborated herein.

Generally, when a mobile terminal simulates a transportation card such as a bus card, the mobile terminal, even with the screen of the mobile terminal locked, can be directly swiped against a turnstile of a bus or a subway to pay for the ride of the bus or the subway.

However, if the mobile terminal also stores a virtual bank card therein, it may impose risk to the safety of the bank card. For example, there may be a mobile POS machine nearby to secretly swipe the virtual bank card to steal money from the bank card.

On the other hand, if the function of the simulation transportation card such as a bus card is disabled, the user may have to activate the function of the simulation of the bus card each time the user wants to swipe the simulated bus card. It can be a convoluted process or a complex operation because several steps of actions may be involved. Therefore, there is a demand for a method for activating a virtual card, which, in case where at least a virtual bank card and a virtual bus card are both stored in the mobile terminal, can be a simple operation involving few actions while ensuring safety of using those virtual cards.

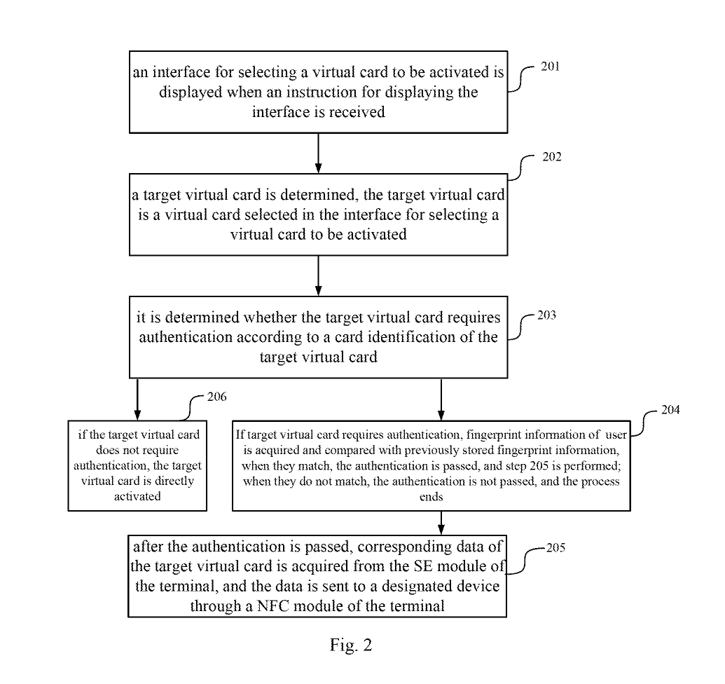

FIG. 2 is a flow chart illustrating a method for activating a virtual card according to an exemplary embodiment. As shown in FIG. 2, the method for activating a virtual card may be applied in a terminal, and may include the following steps.

At step 201, an interface for selecting a virtual card to be activated is displayed when an instruction for displaying the interface is received. The interface for selecting a virtual card to be activated may be configured to display at least two types of virtual cards.

In the embodiment of the present disclosure, the instruction for displaying an interface may be triggered by any one of the following manners.

In a first manner, when a designated device is detected as being within a preset distance, the instruction for displaying an interface is triggered.

In the embodiment, the designated device refers to a device having a short-distance communication capability, such as a POS machine, a turnstile, or an entrance guard machine. Such a designated device may have a short-distance communication module, such as a NFC module, a Blue Tooth module or the like. The above mentioned preset distance may vary depending on the type of the terminal or the type of the designated device. The present disclosure may not be limited to any one or more types of preset distance.

The designated device may be detected as being within a preset distance to the terminal through any one of the following manners. First, the designated device may act as a master device to provide a radio frequency field during the entire communication process. When the terminal acts as a slave device and enters the radio frequency field, the terminal can receive an instruction sent by the master device. After the master device is determined as belonging to a designated device according to the instruction, it may be determined that a designated device is detected as being within a preset distance to the terminal. The instruction may be a payment receiving instruction such as in case of a POS machine or a bus card machine, a discovery instruction such as in case of a POS machine, or an identity-information retrieving instruction such as in case of an entrance guard machine, and so on.

In a second manner, when a designated action with respect to the terminal is detected, the instruction for displaying an interface is triggered.

The designated action may be a gesture such as a triggering action on the screen of the terminal, or a triggering action on a designated component of the terminal, or the like. The triggering action can be of various forms. For example, the triggering action may be successive clicks, extended press on the screen of the terminal. The designated action may also be a triggering action on a designated shortcut icon provided by the terminal. The designated shortcut icon may invoke an interface for selecting a virtual card to be activated.

In the embodiment, the interface for selecting a virtual card to be activated may present at least two types of virtual cards, for example, a virtual bank card and a virtual bus card. Both the two types of virtual cards may be displayed with previously stored card faces. Alternatively, the virtual card may be displayed in other formats. For example, information from both bank card and the bus card may be extracted from the front and back sides of the cards and may be stored in the terminal. And one or more pre-determined formats may be developed and may be used to display in the terminal to contain the information of both two types of cards. As one example, the pre-determined format may be a table and information for cards may be displayed in the table. Also, the pre-determined format may be tokens, and one token may be developed for each type of cards. For instance, the bus card and bank card may have different types of tokens to be displayed. The bus card may be displayed as a bus ticket in the screen of the terminal. The bank card may be displayed as a bank certificate. By displaying different types of virtual cards in different tokens, different types of virtual cards may be easily identified.

The virtual bank card may be associated with a bank account corresponding to the virtual bank card. The virtual bank card may be used for conducting interaction with a backend server for the virtual bank card to perform operations such as making a payment. Generally, for sake of payment safety and security, the virtual bank card stores identification information of the account owner which requires a high level of privacy and safety.

On the other hand, the virtual bus card may be associated with an amount of money that may be charged to the user for a bus ride. The virtual bus card may not involve personal information of the account owner. Thus, the virtual bus card requires a low level of privacy. The payment of the virtual bus card may be conducted without any backend server and may be implemented just in response to a payment instruction. For example, upon receipt of an instruction for a payment of $2, the stored amount of money of the virtual bus card may be deducted by $2.

As illustrated above, at least two types of virtual cards may be stored in as a Secure Element (SE) of the terminal to improve safety and avoid unauthorized access.

At step 202, a target virtual card is determined. The target virtual card is a virtual card selected in the interface for selecting a virtual card to be activated.

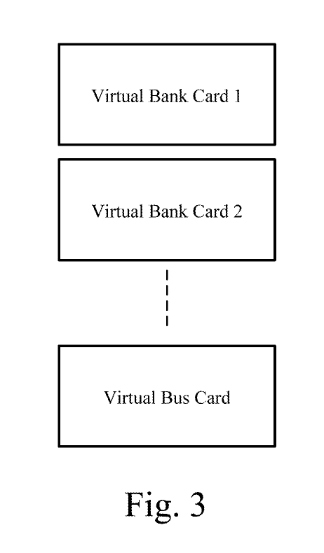

The interface for selecting a virtual card to be activated may be one as shown in FIG. 3. When it is detected that a trigger action is performed with respect to any of the virtual cards in the interface for selecting a virtual card to be activated, it may be considered that the user has selected the virtual card to be activated, and the virtual card corresponding to the trigger action may be determined as the target virtual card.

In the embodiment, the trigger action may be a click, double clicks, an extended press on the screen of the terminal and so on.

At step 203, it is determined whether the target virtual card requires authentication according to a card identification of the target virtual card.

In the embodiment of the present disclosure, the determining process may include: when the card identification of the target virtual card belongs to a first type of identifications, it is determined that the target virtual card requires authentication; and when the card identification of the target virtual card belongs to a second type of identifications, it is determined that the target virtual card does not require authentication.

It should be noted that, each virtual card has a corresponding card identification for uniquely identifying the virtual card. The first type of identifications may be used to identify virtual bank cards, and the second type of identifications may be used to identify virtual bus cards. However, the card identification may also belong to a third type of identifications or other identifications.

It should be noted that, the logic of the determination may be stored in a Trusted Execution Environment (TEE). After the target virtual card is determined or identified, the card identification of the target virtual card may be transmitted into the TEE, and the TEE may perform the determination according to the card identification. Since the TEE is a trusted operation system on the terminal which has safety processing capability and supports peripheral operation, it can improve the security level of the determination by storing the logic of the determination in the TEE and performing the determination by the TEE.

Sometimes, when the virtual cards are displayed as tokens in the screen of the terminal, the type of tokens may be used to determine or identify whether authentication is needed for the virtual card. For example, all virtual cards such as a bus card which do not need the authentication may be displayed in tokens with square or rectangular shapes. On the other hand, all virtual cards such as a bank card that require authentication may be displayed in tokens with round shapes. As such, by assigning the different shapes of tokens for displaying different types of the virtual cards, it can be determined and identified whether the target virtual card requires authentication.

At step 204, if the target virtual card requires authentication, fingerprint information of the user may be acquired, and the acquired fingerprint information may be compared with previously stored fingerprint information. When the acquired fingerprint information matches with the previously stored fingerprint information, the authentication is passed, and step 205 is performed; when the acquired fingerprint information does not match with the previously stored fingerprint information, the authentication is not passed, and the process of the method ends.

When the card identification of the target virtual card belongs to the first type of identifications, it means that the target virtual card requires a high security level, and fingerprint authentication may be provided for the target virtual card. For virtual cards of the first type of identifications, various virtual cards with different card identifications may correspond to different stored fingerprint information to further improve security level. For example, different fingers for the same person or different persons may be associated with different virtual cards. However, the same fingerprint information may also be stored for virtual cards with different identifications. In this case, each of the virtual cards of the first type of identifications may be verified with the same finger, which can be convenient for the user.

For the fingerprint verification, sometimes, 100% match between the acquired fingerprint and the stored fingerprint information may be not required. For example, due to the limitation of the fingerprint acquisition equipment, the acquired fingerprint can be authenticated even though the acquired fingerprint does not match with the stored fingerprint information perfectly. Thus, a threshold such as 85% match may be set to authenticate the acquired fingerprint when the acquired fingerprint does not 100% match the stored fingerprint information and the similarity of both acquired fingerprint and the stored fingerprint information exceeds the pre-defined threshold. The threshold may be defined and set by the user via a user interface for a particular virtual card.

It should be noted that, the fingerprint authentication may also be performed in the TEE. In practice, the authentication may be password authentication or other forms of authentication based on biometric identification technique such as voice authentication, iris authentication, etc. For example, for voice authentication, the user may record a voice in advance, the terminal may extract voiceprint information of the user from the voice and store the extracted voiceprint information. In subsequent authentication process, the similar voiceprint extraction may be performed, and the extracted voiceprint information may be compared with the stored voiceprint information. For the iris authentication, the iris information of the user may be acquired in advance, and the iris information may be stored and used in authentication similar to the above authentication, which is not elaborated herein. 100% match for all above authentications may not be necessary, a threshold may be defined and set by the user via a user interface to a particular virtual card for a particular authentication method.

At step 205, after the authentication is passed, corresponding data of the target virtual card is acquired from the SE module of the terminal, and the data is sent to a designated device through a NFC module of the terminal.

At the above steps 204-205, authentication information to be authenticated is acquired, and after the authentication is passed, the target virtual card is activated. The step 205 is a card simulation process. For short distance communication, after the authentication is passed on the terminal, the card simulation function is enabled to simulate the target virtual card as a physical card. The data of the virtual card is sent to a short-distance communication module, and then sent to the designated device through the short-distance communication module. In the embodiment, the data of the virtual card may include information such as a bank account corresponding to the virtual card for performing a payment operation.

At step 206, if the target virtual card does not require authentication, the target virtual card is activated.

When the card identification of the target virtual card belongs to the second type of identifications, it means the target virtual card requires a relatively low security level. In this case, the card simulation function may be directly enabled to simulate the target virtual card. The data of the virtual card is sent to a short-distance communication module, and then sent to the designated device through the short-distance communication module.

However, alternatively to the above sending process, the designated device may read data from the NFC module of the terminal. The present disclosure should not be limited to any communication methods for sending data from the terminal to the designated device.

In the embodiment of the present disclosure, before the designated device is detected, the card simulation function of the terminal is in a disabled state. Only when a designated device is detected in the vicinity of the terminal, the selection interface is displayed, and it is determined how to activate a virtual card depending on the virtual card selected by the user. By this way, the operation can be simplified to very few actions while the security is ensured.

In particular, in the embodiment, when the virtual cards include a virtual bank card and a virtual bus card, the user may select to activate the virtual bank card or the virtual bus card. When the user selects the virtual bank card, authentication is required to be passed before the card simulation function is enabled to simulate the virtual bank card, that is, to activate the card. When the user selects the virtual bus card, the authentication is not required, and the card simulation function may be directly enabled to simulate the virtual bus card. This can significantly improve the efficiency of the user operation.

In the embodiment of the present disclosure, when the terminal stores more than one type of virtual cards, a selection interface may be provided for the user to select a virtual card, and the specific payment manner may be determined accordingly. Therefore, the operation can be simplified to very few actions. In addition, corresponding process may be performed depending on specific security requirements of payment, therefore, the operation can ensure the safety and security while being simplified.

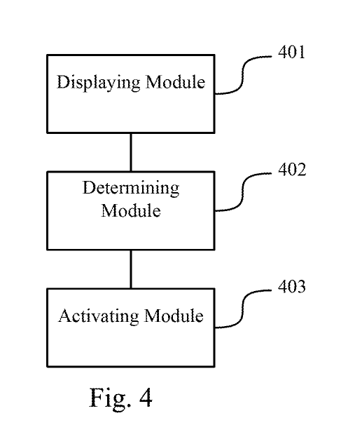

FIG. 4 is a block diagram illustrating an apparatus for activating a virtual card according to an exemplary embodiment. As shown in FIG. 4, the apparatus may include:

a displaying module 401 configured to display an interface for selecting a virtual card to be activated upon receiving an instruction for displaying the interface. The interface for selecting a virtual card to be activated may be configured to display at least two types of virtual cards;

a determining module 402 may be configured to determine a target virtual card. The target virtual card may be a virtual card selected in the interface for selecting a virtual card to be activated.

An activating module 403 may be configured to, if the target virtual card requires authentication, acquire information to be authenticated, and if the authentication is passed, activate the target virtual card; and if the target virtual card does not require authentication, directly activate the target virtual card.

In one possible implementation, the apparatus further may include:

a triggering module configured to, upon detecting a designated device within a preset distance to the terminal, trigger the instruction for displaying the interface; or upon detecting a designated action with respect to the terminal, trigger the instruction for displaying the interface.

In one possible implementation, the apparatus further may include:

a deciding module configured to determine whether the target virtual card requires authentication according to a card identification of the target virtual card; determine that the target virtual card requires authentication if the card identification of the target virtual card belongs to a first type of identifications; and determine that the target virtual card does not require authentication if the card identification of the target virtual card belongs to a second type of identifications.

In one possible implementation, the activating module may be configured to, if the target virtual card requires authentication, acquire fingerprint information of a user; and compare the acquired fingerprint information with previously stored fingerprint information. If the acquired fingerprint information matches with the previously stored fingerprint information, the authentication is passed; and if the acquired fingerprint information does not match with the previously stored fingerprint information, the authentication is not passed.

In one possible implementation, the activating module may be configured to, if the authentication is passed, acquire corresponding data of the target virtual card from a SE module of the terminal, and send the data to a designated device through a NFC module of the terminal.

In one possible implementation, the at least two types of virtual cards may include a virtual bank card and a virtual bus card. The virtual bank card may require authentication, and the virtual bus card may not require authentication.

With respect to the apparatus in the above embodiment, the specific manners for performing operations for individual modules therein have been described in detail in the embodiments regarding the relevant method, which will not be elaborated herein.

It should be noted that, activating a virtual card performed on by the apparatus for activating a virtual card according to the above-described embodiment, is only illustrated by example of divided functional modules as the above-mentioned. While in practical application, the above functions may be assigned to different modules as desired, that is, the internal structure of the apparatus may be divided into different functional modules or circuitries, so as to attain all or part of the functions described above. In addition, the method and the apparatus for activating a virtual card according to the above-described embodiments belong to the same conception, therefore, the detailed implementing processes of the apparatus may refer to those of the embodiments of the method, and the detailed description of which are not given herein repeatedly.

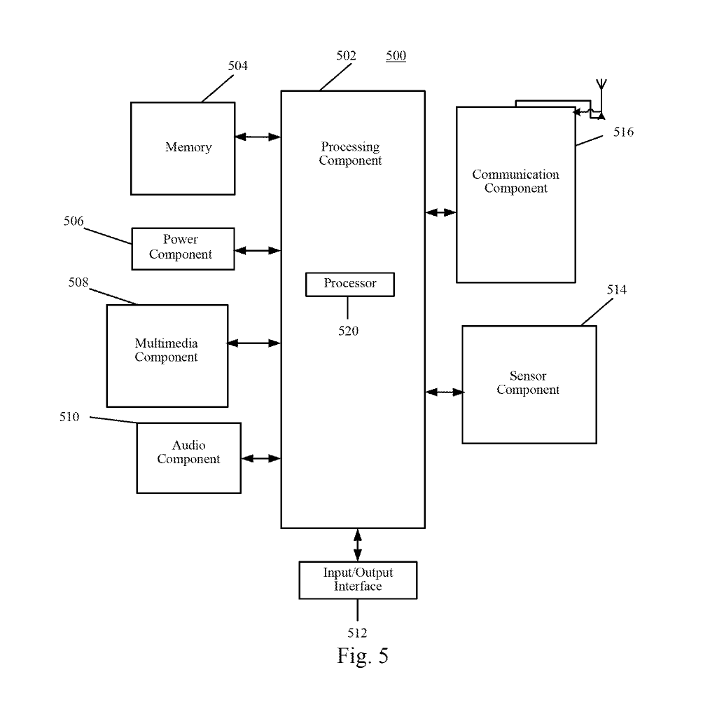

FIG. 5 is a block diagram illustrating an apparatus 500 for activating a virtual card according to an exemplary embodiment. For example, the apparatus 500 may be a mobile phone, a computer, a digital broadcast terminal, a messaging device, a gaming console, a tablet, a medical device, exercise equipment, a personal digital assistant, and the like.

Referring to FIG. 5, the apparatus 500 can include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the apparatus 500, such as the operations associated with display, telephone calls, data communications, camera operations, and recording operations. The processing component 502 can include one or more processors 520 to execute instructions to perform all or part of the steps in the above described methods. Moreover, the processing component 502 can include one or more modules which facilitate the interaction between the processing component 502 and other components. For instance, the processing component 502 can include a multimedia module to facilitate the interaction between the multimedia component 508 and the processing component 502.

The memory 504 may be configured to store various types of data to support the operation of the apparatus 500. Examples of such data include instructions for any applications or methods operated on the apparatus 500, contact data, phonebook data, messages, pictures, video, etc. The memory 504 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the apparatus 500. The power component 506 can include a power management system, one or more power sources, and any other components associated with the generation, management, and distribution of power in the apparatus 500.

The multimedia component 508 may include a screen providing an output interface between the apparatus 500 and the user. In some embodiments, the screen can include a liquid crystal display (LCD) and a touch panel (TP). If the screen may include the touch panel, the screen can be implemented as a touch screen to receive input signals from the user. The touch panel may include one or more touch sensors to sense touches, swipes, and gestures on the touch panel. The touch sensors can not only sense a boundary of a touch or swipe action, but also sense a period of time and a pressure associated with the touch or swipe action. In some embodiments, the multimedia component 508 may include a front camera and/or a rear camera. The front camera and the rear camera can receive an external multimedia datum while the apparatus 500 is in an operation mode, such as a photographing mode or a video mode. Each of the front camera and the rear camera can be a fixed optical lens system or have focus and optical zoom capability.

The audio component 510 may be configured to output and/or input audio signals. For example, the audio component 510 may include a microphone (“MIC”) configured to receive an external audio signal when the apparatus 500 is in an operation mode, such as a call mode, a recording mode, and a voice recognition mode. The received audio signal can be further stored in the memory 504 or transmitted via the communication component 516. In some embodiments, the audio component 510 further may include a speaker to output audio signals.

The I/O interface 512 provides an interface between the processing component 502 and peripheral interface modules, such as a keyboard, a click wheel, buttons, and the like. The buttons can include, but are not limited to, a home button, a volume button, a starting button, and a locking button.

The sensor component 514 may include one or more sensors to provide status assessments of various aspects of the apparatus 500. For instance, the sensor component 514 can detect an open/closed status of the apparatus 500, relative positioning of components, e.g., the display and the keypad, of the apparatus 500, a change in position of the apparatus 500 or a component of the apparatus 500, a presence or absence of user contact with the apparatus 500, an orientation or an acceleration/deceleration of the apparatus 500, and a change in temperature of the apparatus 500. The sensor component 514 can include a proximity sensor configured to detect the presence of nearby objects without any physical contact. The sensor component 514 can also include a light sensor, such as a CMOS or CCD image sensor, for use in imaging applications. In some embodiments, the sensor component 514 can also include an accelerometer sensor, a gyroscope sensor, a magnetic sensor, a pressure sensor, or a temperature sensor.

The communication component 516 may be configured to facilitate communication, wired or wirelessly, between the apparatus 500 and other devices. The apparatus 500 can access a wireless network based on a communication standard, such as WiFi, 2G; or 3G or a combination thereof. In one exemplary embodiment, the communication component 516 receives a broadcast signal or broadcast associated information from an external broadcast management system via a broadcast channel. In one exemplary embodiment, the communication component 516 further may include a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 500 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 504, executable by the processor 520 in the apparatus 500, for performing the above-described methods. For example, the non-transitory computer-readable storage medium can be a ROM, a RAM, a CD-ROM, a magnetic tape, a floppy disc, an optical data storage device, and the like.

A non-transitory computer readable storage medium, when instructions in the storage medium are executed by the processor of the mobile terminal, the mobile terminal is enabled to perform the method for activating a virtual card according to the embodiments as shown above.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors. Sometimes, terms “module,” “sub-module,” “unit,” or “sub-unit” may refer to a circuitry or a circuit that may be designed to perform certain functions.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for activating a virtual card which is applied in a terminal, comprising:
displaying an interface for selecting a virtual card to be activated upon receiving an instruction, wherein the interface for selecting the virtual card to be activated is configured to display at least two types of virtual cards in one or more pre-determined formats;
determining a target virtual card wherein the target virtual card is the virtual card selected in the interface for selecting the virtual card to be activated;
acquiring information to be authenticated when the target virtual card requires authentication, and activating the target virtual card when the authentication is passed; and
directly activating the target virtual card when the target virtual card does not require the authentication.

2. The method of claim 1, further comprising:
triggering the instruction for displaying the interface upon detecting a designated device within a preset distance to the terminal or upon detecting a designated action with respect to the terminal.

3. The method of claim 1, wherein after determining the target virtual card, the method further comprises:
determining whether the target virtual card requires the authentication according to a card identification of the target virtual card; and
determining the target virtual card requires the authentication when the card identification of the target virtual card belongs to a first type of identifications; and
determining the target virtual card does not require the authentication when the card identification of the target virtual card belongs to a second type of identifications.

4. The method of claim 1, wherein acquiring the information to be authenticated when the target virtual card requires the authentication comprises:
acquiring fingerprint information of a user when the target virtual card requires the authentication; and
comparing the acquired fingerprint information with previously stored fingerprint information, and determining that the authentication is passed when the acquired fingerprint information matches with the previously stored fingerprint information and determining that the authentication is not passed and when the acquired fingerprint information does not match with the previously stored fingerprint information.

5. The method of claim 1, wherein activating the target virtual card when the authentication is passed comprises:
acquiring corresponding data of the target virtual card from a SE module of the terminal when the authentication is passed, and
sending the acquired data to a designated device through a NFC module of the terminal.

6. The method of claim 1, wherein the at least two types of virtual cards comprises:
a virtual bank card and a virtual bus card wherein the virtual bank card requires the authentication and the virtual bus card does not require the authentication.

7. An apparatus for activating a virtual card which is applied in a terminal, comprising:
a processor; and
a memory for storing instructions executable by the processor;
wherein the processor is configured to:
display an interface for selecting a virtual card to be activated upon receiving an instruction for displaying the interface, wherein the interface for selecting the virtual card to be activated is configured to display at least two types of virtual cards in one or more pre-determined formats;
determine a target virtual card wherein the target virtual card is the virtual card selected in the interface for selecting the virtual card to be activated;
acquire information to be authenticated when the target virtual card requires authentication, and activate the target virtual card when the authentication is passed; and
directly activate the target virtual card when the target virtual card does not require the authentication.

8. The apparatus of claim 7, wherein the processor is further configured to:
trigger the instruction for displaying the interface upon detecting a designated device within a preset distance to the terminal or upon detecting a designated action with respect to the terminal.

9. The apparatus of claim 7, wherein after the target virtual card is determined, the processor is further configured to:
determine whether the target virtual card requires the authentication according to a card identification of the target virtual card; and
determine the target virtual card requires the authentication when the card identification of the target virtual card belongs to a first type of identifications, and determine the target virtual card does not require the authentication when the card identification of the target virtual card belongs to a second type of identifications.

10. The apparatus of claim 7, wherein the processor configured to acquire information to be authenticated when the target virtual card requires the authentication is further configured to:
acquiring fingerprint information of a user when the target virtual card requires the authentication; and
comparing the acquired fingerprint information with previously stored fingerprint information, and determine that the authentication is passed when the acquired fingerprint information matches with the previously stored fingerprint information and determine that the authentication is not passed when the acquired fingerprint information does not match with the previously stored fingerprint information.

11. The apparatus of claim 7, wherein the processor configured to activate the target virtual card when the authentication is passed is further configured to:
acquire corresponding data of the target virtual card from a SE module of the terminal when the authentication is passed, and
send the acquired data to a designated device through a NFC module of the terminal.

12. The apparatus of claim 7, wherein the at least two types of virtual cards comprises:
a virtual bank card and a virtual bus card wherein the virtual bank card requires the authentication and the virtual bus card does not require the authentication.

13. A non-transitory computer-readable storage medium storing instructions, executable by a processor in an apparatus for activating a virtual card in a terminal, cause the processor to perform:
displaying an interface for selecting a virtual card to be activated upon receiving an instruction for displaying the interface, wherein the interface for selecting the virtual card to be activated is configured to display at least two types of virtual cards;
determining a target virtual card wherein the target virtual card is the virtual card selected in the interface for selecting the virtual card to be activated;
acquiring information to be authenticated when the target virtual card requires authentication, and activating the target virtual card when the authentication is passed; and
directly activating the target virtual card when the target virtual card does not require the authentication.

14. The non-transitory computer-readable storage medium of claim 13, wherein the instructions further cause the processor to perform:
triggering the instruction for displaying the interface upon detecting a designated device within a preset distance to the terminal or upon detecting a designated action with respect to the terminal.

15. The non-transitory computer-readable storage medium of claim 13, wherein, after the instructions cause the processor to perform determining the target virtual card, the instructions further cause the processor to perform:
determining whether the target virtual card requires the authentication according to a card identification of the target virtual card; and
determining the target virtual card requires the authentication when the card identification of the target virtual card belongs to a first type of identifications; and
determining the target virtual card does not require the authentication when the card identification of the target virtual card belongs to a second type of identifications.

16. The non-transitory computer-readable storage medium of claim 13, wherein the instructions caused the processor to perform acquiring information to be authenticated when the target virtual card requires authentication further cause the processor to perform:
acquiring fingerprint information of a user when the target virtual card requires the authentication; and
comparing the acquired fingerprint information with previously stored fingerprint information, and determining that the authentication is passed when the acquired fingerprint information matches with the previously stored fingerprint information and determining that the authentication is not passed when the acquired fingerprint information does not match with the previously stored fingerprint information.

17. The non-transitory computer-readable storage medium of claim 13, wherein the instructions caused the processor to perform activating the target virtual card when the authentication is passed further cause the processor to perform:
acquiring corresponding data of the target virtual card from a SE module of the terminal when the authentication is passed, and
sending the acquired data to a designated device through a NFC module of the terminal.

18. The non-transitory computer-readable storage medium of claim 13, wherein the at least two types of virtual cards comprises:
a virtual bank card and a virtual bus card wherein the virtual bank card requires the authentication, and the virtual bus card does not require the authentication.
